(19) United States
(12) Patent Application Publication
(10) Pub. No.: US 2024/0175349 A1
(43) Pub. Date: May 30, 2024

(54) UNTETHERED DOWNHOLE TOOLS AND RELATED METHODS OF GENERATING VERTICAL SEISMIC PROFILES

(71) Applicant: Saudi Arabian Oil Company, Dhahran (SA)

(72) Inventors: Huseyin Rahmi Seren, Houston, TX (US); Max Deffenbaugh, Fulshear, TX (US); Ahmed Y. Bukhamseen, Dammam (SA); Harold WK Merry, Houston, TX (US); Farhan Naseer, Katy, TX (US)

(21) Appl. No.: 18/072,197

(22) Filed: Nov. 30, 2022

(51) Int. Cl. E21B 47/085; E21B 47/07; E21B 47/095; E21B 47/12

(52) U.S. Cl. CPC E21B 47/085; E21B 47/07; E21B 47/095; E21B 47/138

(57) ABSTRACT

This disclosure discusses methods and apparatus for generating vertical seismic profiles of a subsurface formation though deploying an untethered downhole tool into a wellbore, the untethered tool including at least one seismic sensor, a ballast, and a first electromagnet in the untethered downhole tool to attach the untethered downhole tool to a casing of the wellbore at a predetermined depth. The method further includes transmitting a seismic signal into the subsurface formation from a source located above the subsurface formation, receiving the seismic signal with the at least one seismic sensor, deactivating the first electromagnet to release the untethered downhole tool from the casing of the wellbore, releasing the ballast from the untethered downhole tool such that buoyancy effects move the tool uphole, and retrieving the untethered downhole tool from the wellbore.

### TECHNICAL FIELD

This disclosure relates to generating vertical seismic profiles using untethered downhole tools that include a relatively buoyant component for floating to the surface once a ballast weight has been released from the tool.

### BACKGROUND

In geology, sedimentary facies are bodies of sediment that are recognizably distinct from adjacent sediments that resulted from different depositional environments. Generally, geologists distinguish facies by aspects of the rock or sediment being studied. Seismic facies are groups of seismic reflections whose parameters (such as amplitude, continuity, reflection geometry, and frequency) differ from those of adjacent groups. Seismic facies analysis, a subdivision of seismic stratigraphy, plays an important role in hydrocarbon exploration and is one key step in the interpretation of seismic data for reservoir characterization. The seismic facies in a given geological area can provide useful information, particularly about the types of sedimentary deposits and the anticipated lithology.

In reflection seismology, geologists and geophysicists perform seismic surveys to map and interpret sedimentary facies and other geologic features for applications, for example, identification of potential petroleum reservoirs. Seismic surveys are conducted by using a controlled seismic source (for example, a seismic vibrator or dynamite) to create seismic waves. The seismic source is typically located at ground surface. Seismic body waves travel into the ground, are reflected by subsurface formations, and return to the surface where they recorded by sensors called geophones. Seismic surface waves travel along the ground surface and diminish as they get further from the surface. Seismic surface waves travel more slowly than seismic body waves. The geologists and geophysicists analyze the time it takes for the seismic body waves to reflect off subsurface formations and return to the surface to map sedimentary facies and other geologic features. Similarly, analysis of the time it takes seismic surface waves to travel from source to sensor can provide information about near surface features. This analysis can also incorporate data from sources, for example, borehole logging, gravity surveys, and magnetic surveys.

One approach to this analysis is based on tracing and correlating along continuous reflectors throughout the dataset produced by the seismic survey to produce structural maps that reflect the spatial variation in depth of certain facies. These maps can be used to identify impermeable layers and faults that can trap hydrocarbons such as oil and gas.

### SUMMARY

Vertical seismic profiling (VSP) is a technique of seismic survey used for correlation with surface seismic data. The defining characteristic of a VSP is that either the energy source, or the detector tools (or sometimes both) are located in a wellbore. This disclosure relates to an approach to generating VSP profiles using an untethered downhole tool that includes a relatively buoyant component for floating to the surface once a ballast weight has been released from the tool.

In an aspect, methods for generating vertical seismic profile of a subsurface formation include: deploying an untethered downhole tool into a wellbore, the untethered tool including: at least one seismic sensor; and ballast such that, with the ballast, the untethered downhole tool has a higher density than fluid in the wellbore and, without the ballast, the untethered downhole tool has a lower density than fluid in the wellbore; activating a first electromagnet in the untethered downhole tool to attach the untethered downhole tool to a casing of the wellbore at a predetermined depth; transmitting a seismic signal into the subsurface formation from a source located above the subsurface formation; and receiving, with the at least one seismic sensor, the seismic signal; deactivating the first electromagnet to release the untethered downhole tool from the casing of the wellbore; releasing the ballast from the untethered downhole tool such that buoyancy effects move the tool uphole; and retrieving the untethered downhole tool from the wellbore.

In an aspect, sensor apparatus include: a microcontroller further comprising; an internal memory structure, wherein the memory structure contains data on predetermined times the deployable sensor is to measure data; and contains predetermined times where the deployable sensor is to activate or deactivate one or more electromagnets. The apparatus also includes a precision timer; one or more electromagnets; and a form of ballast that electromagnetically couples to the one or more electromagnets.

Some embodiments of these methods and systems include one or more of the following features.

In some embodiments, the untethered tool includes multiple seismic sensors.

In some embodiments, the first electromagnet deactivates and later reactivates to attach the untethered downhole tool to a different location in the wellbore.

In some embodiments, fall time is used to determine depth of the untethered downhole tool in the wellbore.

In some embodiments, multiple predetermined depths are loaded onto the untethered downhole tool corresponding to where data is to be measured onto an internal memory structure.

In some embodiments, one or more measurements are taken while descending to the predetermined depth.

In some embodiments, one or more measurements are taken while ascending for retrieval.

In some embodiments, multiple untethered downhole tools are deployed in the same wellbore. In some cases, one untethered downhole tool is deployed for each predetermined depth. In some cases, the first electromagnets deactivate and later reactivate to attach the untethered downhole tools to different locations in the wellbore. In some cases, the deactivation and reactivation of the first electromagnets is synchronized for the multiple untethered downhole tools. In some cases, the deactivation and reactivation of the first electromagnets is synchronized such that only one untethered downhole tool is retrieved at a time.

In some embodiments, the deployable sensor is a seismic sensor.

In some embodiments, the deployable sensor includes a geophone, hydrophone, accelerometer, or fiber optic sensor.

In some embodiments, the deployable sensor includes additional sensors for pressure, temperature, electromagnetism, acceleration, casing collar location and gamma rays.

In some embodiments, the one or more electromagnets include multiple groups of electromagnets. In some cases, at least one of the multiple groups of electromagnets are positioned to electromagnetically couple the buoyant deployable sensor apparatus to a ferrous surface. In some cases, the ferrous surface is a wellbore.

In some embodiments, the ballast is positioned such that gravity separates it from the buoyant deployable sensor apparatus upon deactivating the one or more electromagnets.

Advantages to using an untethered downhole tool in place of a traditional wireline tool include: reduced operating cost, faster measurement completion, simultaneous measurement of multiple wellbores, improved field safety, and smaller operational support requirements leading to a reduced greenhouse gas footprint.

The details of one or more embodiments of these systems and methods are set forth in the accompanying drawings and the description to be presented. Other features, objects, and advantages of these systems and methods will be apparent from the description and drawings, and from the claims.

### DESCRIPTION OF DRAWINGS

FIG. 1A illustrates a schematic view of a seismic survey being performed to map subterranean features such as facies and faults.

FIG. 1B illustrates a schematic view of a VSP survey being performed to map subterranean features such as facies and faults with an untethered downhole tool.

FIG. 2 illustrates an example untethered downhole tool.

FIGS. 3A, 3B, and 3C illustrate different deployment modes for the untethered downhole tools.

FIG. 4 is a flow diagram of an example process for deploying an untethered downhole tool.

FIG. 5 is a block diagram illustrating an example computer system used to provide computational functionalities associated with described algorithms, methods, functions, processes, flows, and procedures as described in the present disclosure, according to some implementations of the present disclosure.

Like reference symbols in the various drawings indicate like elements.

### DETAILED DESCRIPTION

Vertical seismic profiling (VSP) (including Velocity/Check Shot Surveying) is a technique of borehole seismic survey used for correlation with surface seismic data. The defining characteristic of a VSP is that either the energy source, or the detector tools (or sometimes both) are located in a wellbore. This disclosure relates to an approach to generating VSP profiles using an untethered downhole tool that includes a relatively buoyant component for floating to the surface once a ballast weight has been released from the tool.

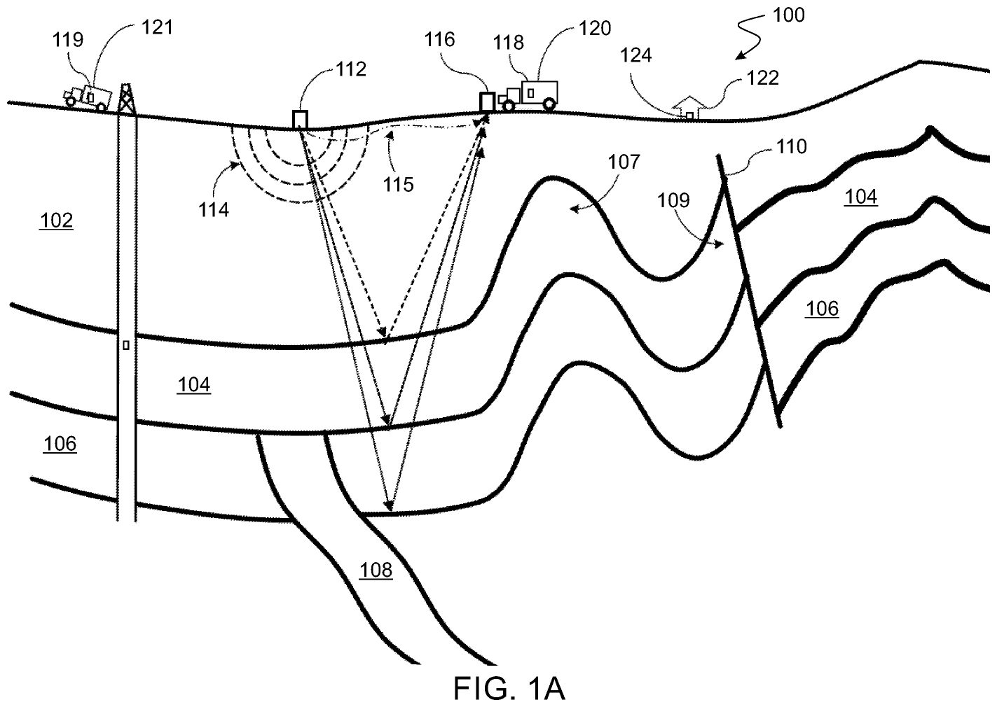

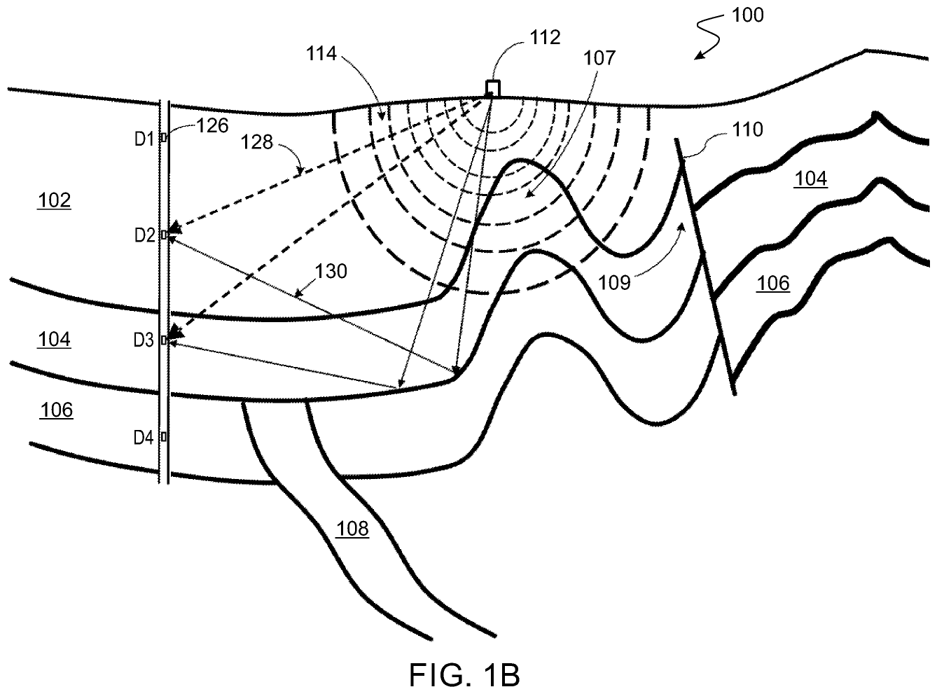

FIG. 1A illustrates a schematic view of a seismic survey being performed with an untethered downhole tool to map subterranean features such as facies and faults in a subterranean formation 100. This untethered downhole tool includes a seismic sensor, among other things. The subterranean formation 100 includes a layer of impermeable cap rock 102 at the surface. Facies underlying the impermeable cap rocks 102 include a sandstone layer 104, a limestone layer 106, and a sand layer 108. A fault line 110 extends across the sandstone layer 104 and the limestone layer 106.

Oil and gas tend to rise through permeable reservoir rock until further upward migration is blocked, for example, by the layer of impermeable cap rock 102. Seismic surveys attempt to identify locations where interaction between layers of the subterranean formation 100 are likely to trap oil and gas by limiting this upward migration. For example, FIGS. 1A and 1B show an anticline trap 107, where the layer of impermeable cap rock 102 has an upward convex configuration, and a fault trap 109, where the fault line 110 might allow oil and gas to flow in with clay material between the walls traps the petroleum. Other traps include salt domes and stratigraphic traps.

A seismic source 112 (for example, a seismic vibrator or implosive sources) generates seismic waves that propagate in the earth. Although illustrated as a single component in FIG. 1A, the source or sources 112 are typically a line or an array of sources 112. The generated seismic waves include seismic body waves 114 that travel into the ground and seismic surface waves 115 travel along the ground surface and diminish as they get further from the surface.

The velocity of these seismic waves depends on properties, for example, density, porosity, and fluid content, of the medium through which the seismic waves are traveling. Different geologic bodies or layers in the earth are distinguishable because the layers have different properties and, thus, different characteristic seismic velocities. For example, in the subterranean formation 100, the velocity of seismic waves traveling through the subterranean formation 100 will be different in the sandstone layer 104, the limestone layer 106, and the sand layer 108. As the seismic body waves 114 contact interfaces between geologic bodies or layers that have different velocities, each interface reflects some of the energy of the seismic wave and refracts some of the energy of the seismic wave. Such interfaces are sometimes referred to as horizons.

The seismic body waves 114 are received by a sensor or sensors 116. Although illustrated as a single component in FIG. 1A, the sensor or sensors 116 are typically a line or an array of sensors 116 that generate an output signal in response to received seismic waves including direct arrival waves and waves reflected by the horizons in the subterranean formation 100. The sensors 116 can be geophone-receivers that produce electrical output signals transmitted as input data, for example, to a computer 118 on a seismic recording truck 120. Based on the input data, the computer 118 may generate a seismic data output, for example, a seismic one or two-way response time plot.

The seismic surface waves 115 travel more slowly than seismic body waves 114. Analysis of the time it takes seismic surface waves 115 to travel from source to sensor can provide information about near surface features.

A control center 122 can be operatively coupled to the seismic control truck 120 and other data acquisition and wellsite systems. The control center 122 may have computer facilities for receiving, storing, processing, and analyzing data from the seismic recording truck 120 and other data acquisition and wellsite systems that provide additional information about the subterranean formation. For example, the control processing center 122 can receive data from a computer 119 associated with a well logging unit 121. For example, computer systems 124 in the control processing center 122 can be configured to analyze, model, control, optimize, or perform management tasks of field operations associated with development and production of resources such as oil and gas from the subterranean formation 100. Alternatively, the computer systems 124 can be located in a different location than the control processing center 122. Some computer systems are provided with functionality for manipulating and analyzing the data, such as performing seismic interpretation or borehole resistivity image log interpretation to identify geological surfaces in the subterranean formation or performing simulation, planning, and optimization of production operations of the wellsite systems.

Vertical seismic profiling (VSP) is a technique of seismic survey used for correlation with surface seismic data. The defining characteristic of a VSP is that either the energy source, or the detector tools (or sometimes both) are located in a wellbore.

FIG. 1B illustrates a schematic view of a seismic survey being performed to map subterranean features such as facies and faults with an untethered downhole tool 126 to generate a VSP.

In some applications, seismic data are acquired with downhole sources and receivers. If the receiver is stationed at various depth levels in a wellbore and the source remains on the surface, the measurement is called vertical seismic profiling (VSP) (or a Velocity/Check Shot survey). This technique produces a high-resolution velocity profile, and 2D or 3D image that begins at the receiver well and extends a certain distance (for example, a few tens of meters or a few hundred meters, depending on the source offset distance) toward the source station. This image (a 2D profile restricted to the vertical plane passing through the source and receiver coordinates) is useful in tying seismic responses to subsurface geologic and engineering control.

In VSP, a seismic sensor is positioned at a sequence of selected depths so that the receiver occupies a succession of vertical stations. This receiver records the total seismic wavefield, both downgoing and upgoing events, produced by a surface-positioned energy source. A typical VSP consists of 75 to 1000s of receiver stations depending on depth of the borehole, however more or less stations may be used in some applications.

The vertical spacing between successive stations is typically a few tens of feet. For example, a common receiver spacing is 50 ft (15 m). More or less spacing may be used on some applications. The horizontal distance, X, between the surface source and the downhole receiver is the offset and can assume different magnitudes, depending on the specific VSP imaging application. While, FIG. 1A depicts a VSP measurement made in a vertical wellbore, the VSP technique can also be implemented in deviated or horizontal wells.

In an exemplary application similar to the illustrated schematic, the untethered downhole tool 126 contains a seismic sensor and takes measurements at one or more locations in the well, for example, positions D1-D4. In other embodiments, the untethered downhole tool may contain additional seismic sensors, or sensors of a different type including, for example, hydrostatic pressure sensors, gamma ray detectors, magnetometers, and casing collar locators.

In this embodiment, the seismic sensor in the untethered downhole tool 126 measures data at fixed timing intervals that correspond to well depths. The tool is stabilized at these depths through the use of an electromagnet that attaches the tool to the wellbore. Following tool retrieval, the recorded acoustic data is then concentrated into individual data records using the precise timing of the source 112 transmissions. This method is referred to as “nodal” or “cable-less” recording. In other embodiments, different forms of data collection may be used, to include continuously recording acoustic data after deployment. The acoustic data measured by the untethered downhole tool 126 can include seismic waves that arrive either by direct path transmission 128 or by reflection 130.

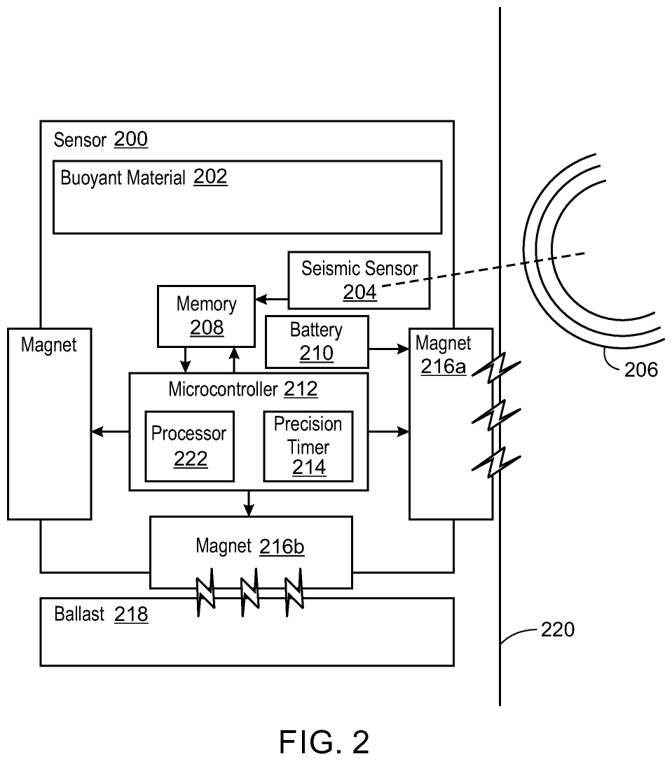

FIG. 2 is a schematic view of an example untethered downhole tool. The untethered downhole tool, or sensor, 200 includes buoyant material 202, one or more seismic sensors 204, a memory 208, a battery 210, a microcontroller 212, a precision timer 214, three magnets 216, a form of ballast 218, and one or more processors 222.

When initially deployed in a wellbore, the untethered downhole tool 200 includes a magnetically attached ballast 218. The ballast 218 is constructed of a ferrous material to facilitate attachment to one or more electromagnets 216. The ballast 218 is constructed such that, when attached to the untethered downhole tool 200, it causes the tool to sink in the wellbore fluid. The untethered downhole tool 200 is also constructed such that when the ballast 218 is released, the density of the untethered downhole tool 200 alone causes the tool to rise in the wellbore fluid. In some cases, the untethered downhole tool 200 is constructed with buoyant material 202 to aid in the ascent of the sensor after the ballast 218 is released.

In this tool, the buoyant material 202 is positioned within the upper body of the untethered downhole tool 200. In some embodiments, the buoyant material 202 is positioned in other locations. The buoyant material 202 is made of one or more relatively low-density materials to lower an overall density of the untethered downhole tool 200. The buoyant material 202 increases an overall buoyancy of the untethered downhole tool 200. For example, the effect of the buoyant material 202 is that, once the ballast 218 has been separated from the untethered downhole tool 200, the overall density of the untethered downhole tool 200 is low enough (e.g., less than that of the wellbore fluid) to cause the untethered downhole tool 200 to float in the uphole direction back to the surface.

The ballast 218 is attached to the sensor with one or more electromagnets 216b. These electromagnets 216 receive power from an onboard power source (e.g. battery 210) and activation of the electromagnets 216 is controlled by a control system (e.g. microcontroller 212). Operations directed by the microcontroller 212 may be processed by one or more processors 222. In this tool, there are multiple electromagnet 216 groups: one positioned on the side of the untethered downhole tool 200, and one positioned on the bottom of the untethered downhole tool 200. In this arrangement, one set of electromagnets 216b can control ballast 218 attachment, while the other set of electromagnets 216a can control attachment of the untethered downhole tool 200 to a metallic surface, for example, the side of a wellbore 220.

The activation of the electromagnets 216 may be controlled by a control system, in this example embodiment, a microcontroller 212. The untethered downhole tool 200 may be deployed with instructions contained in the microcontroller 212 to activate or deactivate the electromagnets 216 at predetermined times. The microcontroller 212 is assumed to have operational control of the battery 210 output or power source in this example. In some embodiments, the microcontroller 212 includes a precision timer 214. In this embodiment, this precision timer 214 may be used to determine an elapsed time since tool deployment. This elapsed time may trigger one or more events, for example, deactivating electromagnet group 216b to release the ballast 218. Another example could be activating electromagnet group 216a to attach the untethered downhole tool 200 to the wellbore 220. Other embodiments may use other instructions contained in microcontroller 212, to include instructions based on wellbore pressure, physical contact, or the receipt of one or more seismic signals 206.

The untethered downhole tool 200 includes one or more seismic sensors 204 to detect one or more seismic signals 206. These seismic sensors 204 may be connected to a means of storing data (e.g. memory 208). In some embodiments, the untethered downhole tool 200 may be deployed such that the seismic sensors 204 are continually detecting a seismic signal 206. In other embodiments, the untethered downhole tool 200 may be magnetically attached to the wellbore 220 in certain locations to measure one or more seismic signals 206.

The measuring of seismic signals 206 may be sequenced with the activation of the one or more electromagnet groups 216. For example, after a predetermined number of seismic signal measurements, the microcontroller 212 in the untethered downhole tool 200 may order the electromagnets 216b to release the ballast 218 so the untethered downhole tool 200 may rise in the wellbore fluid for collection. In another example, after the microcontroller 212 orders the electromagnets 216a to attach the untethered downhole tool 200 to the wellbore casing 220, the microcontroller 212 may order the deactivation of electromagnets 216a to release the untethered downhole tool 200 from the wellbore casing after a certain number of seismic signals 206 are detected and logged by the seismic sensor 204. Additional sequences of electromagnet 216 operation with respect to sensor measurements are possible, and these sequences may be different than what is described above if different sensors are deployed on the untethered downhole tool 200. The features above may be processed by one or more processors 222 in communication with various components in the untethered downhole tool 200.

Additional sensors in the untethered downhole tool 200 may also measure one or more other physical, chemical, geological, or structural properties along the wellbore during a logging operation. Example additional sensors include pressure sensors, gamma ray detectors, magnetometers, and casing collar locators, among others. Example properties include elapsed time, temperature, and pressure.

The weight of the untethered downhole tool 200 is distributed (e.g., a center of gravity of the untethered downhole tool 200 is located) such that the untethered downhole tool 200 remains substantially in the upright orientation shown in FIG. 2 at all times (e.g., including while descending and ascending within the wellbore fluid). Such an orientation ensures that the ballast 218 faces substantially in the downhole direction at all times.

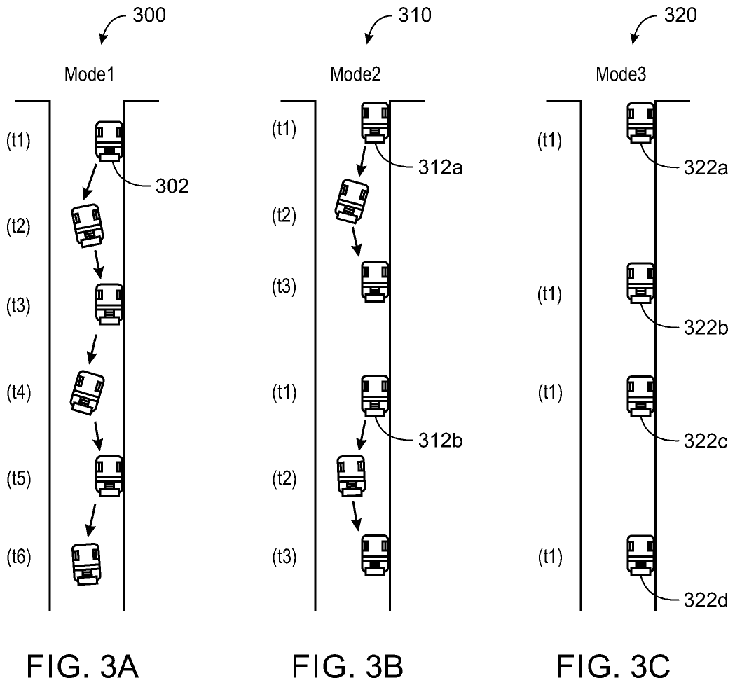

FIGS. 3A, 3B, and 3C illustrate different deployment modes for the untethered downhole tools.

FIG. 3A illustrates a mode where one untethered downhole tool 200 is deployed in a wellbore. In this deployment mode, the untethered downhole tool 200 is programed to attach to the wellbore at one or more measurement sites 302. After data collection, the untethered downhole tool 200 is then detached from the wellbore casing and allowed to sink further in the wellbore to the next measurement site. In this mode, the untethered downhole tool 200 may also collect data while in transit to the next location site 302. While six data measurement times are illustrated (T1 through T6), there is no limit to how many times a measurement may be conducted using this method.

FIG. 3B illustrates a mode where multiple untethered downhole tools 200 are deployed in the same wellbore. In this mode, the untethered downhole tools 200 may be attached to the wellbore casing at measurement sites 312a and 312b similar to what is described in FIG. 3A. In this example mode 310, the operation of the electromagnets may be sequenced such that the untethered downhole tools 200 move in a predetermined motion. This predetermined motion could include the untethered downhole tools 200 moving to their next location site in unison, or the untethered downhole tools 200 releasing their ballast in such a way that only one untethered downhole tool 200 rises in the wellbore for collection at a time. While three data measurement times are illustrated for each untethered downhole tool 200 (T1-T3), there is no limit to how many times a measurement may be conducted using this method.

FIG. 3C illustrates a mode where one untethered downhole tool 200 is deployed for each measurement site 320. In this mode, the untethered downhole tools 200 may be attached to the wellbore casing at measurement sites 322a through 322d similar to what is described in FIG. 3A. In this example mode 320, the operation of the electromagnets may be sequenced such that the untethered downhole tools 200 move in a predetermined way, similar to what is described in FIG. 3B.

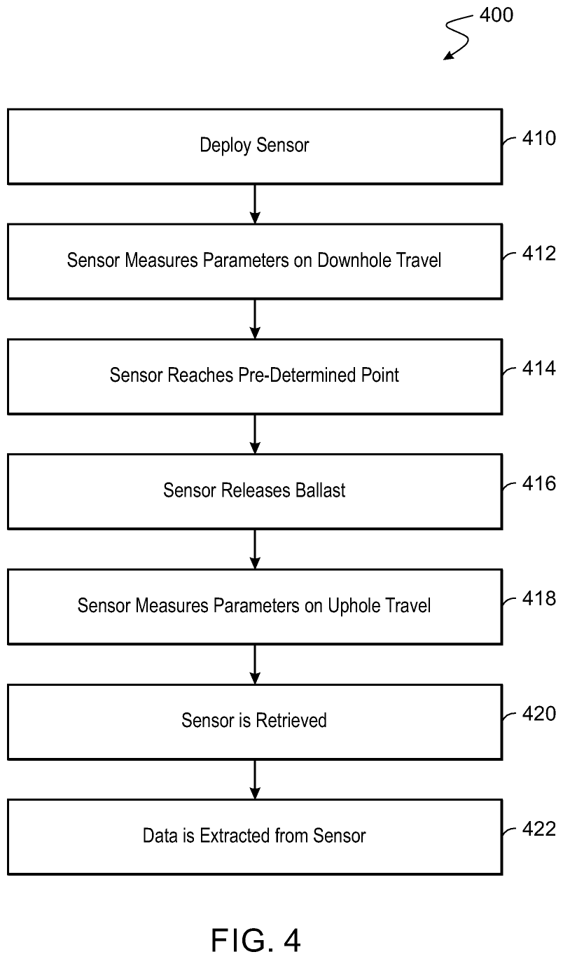

FIG. 4 is a flow diagram of an example process for deploying an untethered downhole tool 400. This example process 400 includes deploying the untethered downhole tool 410, measuring one or more parameters during downhole travel in the wellbore 412, the untethered downhole tool reaching a predetermined point in the wellbore 414, the untethered downhole tool releasing the ballast 416, measuring one or more parameters during uphole travel in the wellbore 412, retrieving the untethered downhole tool 420, and extracting the measured data from the untethered downhole tool 422.

It should be noted that the measuring of parameters during downhole and uphole travel in 412 and 418, respectively, may further include attaching the untethered downhole tool to the wellbore casing for one or more parameter measurements. Additionally, the deploying of an untethered downhole tool 410 may actually be the deployment of multiple untethered downhole tools. Further, deployment of subsequent untethered downhole tools may occur while earlier deployed untethered downhole tools have begun to execute subsequent steps of this example process. For example, an untethered downhole tool that is deployed first may begin to measure parameters prior to the deployment of a second untethered downhole tool. Similarly, the retrieval of the untethered downhole tool 420 may occur for one tool while other tools are still executing steps of this example process. Additionally, there is no constraint on how data may be extracted 422 from multiple untethered downhole tools.

While the untethered downhole tool 200 has been described and illustrated with respect to certain dimensions, sizes, shapes, arrangements, materials, and methods, in some embodiments, an untethered downhole tool 200 that is otherwise substantially similar in construction and function to the untethered downhole tool 200 may include one or more different dimensions, sizes, shapes, arrangements, configurations, and materials or may be utilized according to different methods.

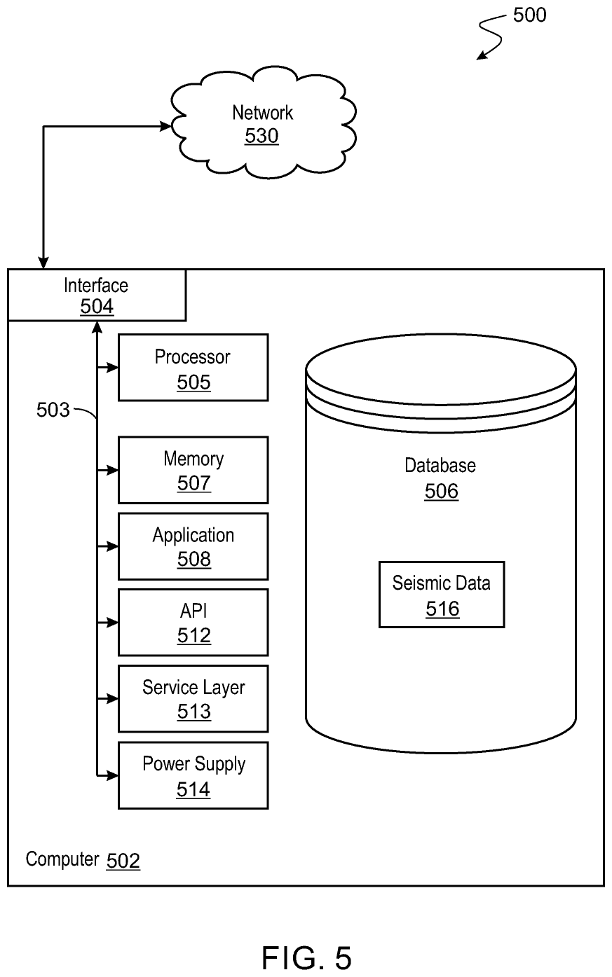

FIG. 5 is a block diagram of an example computer system 500 used to provide computational functionalities associated with described algorithms, methods, functions, processes, flows, and procedures described in the present disclosure, according to some implementations of the present disclosure. The illustrated computer 502 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 502 can include input devices such as keypads, keyboards, and touch screens that can accept user information. Also, the computer 502 can include output devices that can convey information associated with the operation of the computer 502. The information can include digital data, visual data, audio information, or a combination of information. The information can be presented in a graphical user interface (UI) (or GUI).

The computer 502 can serve in a role as a client, a network component, a server, a database, a persistency, or components of a computer system for performing the subject matter described in the present disclosure. The illustrated computer 502 is communicably coupled with a network 530. In some implementations, one or more components of the computer 502 can be configured to operate within different environments, including cloud-computing-based environments, local environments, global environments, and combinations of environments.

At a high level, the computer 502 is an electronic computing device operable to receive, transmit, process, store, and manage data and information associated with the described subject matter. According to some implementations, the computer 502 can also include, or be communicably coupled with, an application server, an email server, a web server, a caching server, a streaming data server, or a combination of servers.

The computer 502 can receive requests over network 530 from a client application (for example, executing on another computer 502). The computer 502 can respond to the received requests by processing the received requests using software applications. Requests can also be sent to the computer 502 from internal users (for example, from a command console), external (or third) parties, automated applications, entities, individuals, systems, and computers.

Each of the components of the computer 502 can communicate using a system bus 503. In some implementations, any or all of the components of the computer 502, including hardware or software components, can interface with each other or the interface 504 (or a combination of both), over the system bus 503. Interfaces can use an application programming interface (API) 512, a service layer 513, or a combination of the API 512 and service layer 513. The API 512 can include specifications for routines, data structures, and object classes. The API 512 can be either computer-language independent or dependent. The API 512 can refer to a complete interface, a single function, or a set of APIs.

The service layer 513 can provide software services to the computer 502 and other components (whether illustrated or not) that are communicably coupled to the computer 502. The functionality of the computer 502 can be accessible for all service consumers using this service layer. Software services, such as those provided by the service layer 513, can provide reusable, defined functionalities through a defined interface. For example, the interface can be software written in JAVA, C++, or a language providing data in extensible markup language (XML) format. While illustrated as an integrated component of the computer 502, in alternative implementations, the API 512 or the service layer 513 can be stand-alone components in relation to other components of the computer 502 and other components communicably coupled to the computer 502. Moreover, any or all parts of the API 512 or the service layer 513 can be implemented as child or sub-modules of another software module, enterprise application, or hardware module without departing from the scope of the present disclosure.

The computer 502 includes an interface 504. Although illustrated as a single interface 504 in FIG. 5, two or more interfaces 504 can be used according to particular needs, desires, or particular implementations of the computer 502 and the described functionality. The interface 504 can be used by the computer 502 for communicating with other systems that are connected to the network 530 (whether illustrated or not) in a distributed environment. Generally, the interface 504 can include, or be implemented using, logic encoded in software or hardware (or a combination of software and hardware) operable to communicate with the network 530. More specifically, the interface 504 can include software supporting one or more communication protocols associated with communications. As such, the network 530 or the hardware of the interface can be operable to communicate physical signals within and outside of the illustrated computer 502.

The computer 502 includes a processor 505. Although illustrated as a single processor 505 in FIG. 5, two or more processors 505 can be used according to particular needs, desires, or particular implementations of the computer 502 and the described functionality. Generally, the processor 505 can execute instructions and can manipulate data to perform the operations of the computer 502, including operations using algorithms, methods, functions, processes, flows, and procedures as described in the present disclosure.

The computer 502 also includes a database 506 that can hold data (for example, seismic data 516) for the computer 502 and other components connected to the network 530 (whether illustrated or not). For example, database 506 can be an in-memory, conventional, or a database storing data consistent with the present disclosure. In some implementations, database 506 can be a combination of two or more different database types (for example, hybrid in-memory and conventional databases) according to particular needs, desires, or particular implementations of the computer 502 and the described functionality. Although illustrated as a single database 506 in FIG. 5, two or more databases (of the same, different, or combination of types) can be used according to particular needs, desires, or particular implementations of the computer 502 and the described functionality. While database 506 is illustrated as an internal component of the computer 502, in alternative implementations, database 506 can be external to the computer 502.

The computer 502 also includes a memory 507 that can hold data for the computer 502 or a combination of components connected to the network 530 (whether illustrated or not). Memory 507 can store any data consistent with the present disclosure. In some implementations, memory 507 can be a combination of two or more different types of memory (for example, a combination of semiconductor and magnetic storage) according to particular needs, desires, or particular implementations of the computer 502 and the described functionality. Although illustrated as a single memory 507 in FIG. 5, two or more memories 507 (of the same, different, or combination of types) can be used according to particular needs, desires, or particular implementations of the computer 502 and the described functionality. While memory 507 is illustrated as an internal component of the computer 502, in alternative implementations, memory 507 can be external to the computer 502.

The application 508 can be an algorithmic software engine providing functionality according to particular needs, desires, or particular implementations of the computer 502 and the described functionality. For example, application 508 can serve as one or more components, modules, or applications. Further, although illustrated as a single application 508, the application 508 can be implemented as multiple applications 508 on the computer 502. In addition, although illustrated as internal to the computer 502, in alternative implementations, the application 508 can be external to the computer 502.

The computer 502 can also include a power supply 514. The power supply 514 can include a rechargeable or non-rechargeable battery that can be configured to be either user- or non-user-replaceable. In some implementations, the power supply 514 can include power-conversion and management circuits, including recharging, standby, and power management functionalities. In some implementations, the power-supply 514 can include a power plug to allow the computer 502 to be plugged into a wall socket or a power source to, for example, power the computer 502 or recharge a rechargeable battery.

There can be any number of computers 502 associated with, or external to, a computer system containing computer 502, with each computer 502 communicating over network 530. Further, the terms “client,” “user,” and other appropriate terminology can be used interchangeably, as appropriate, without departing from the scope of the present disclosure. Moreover, the present disclosure contemplates that many users can use one computer 502 and one user can use multiple computers 502.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

A number of embodiments of these systems and methods have been described. Nevertheless, it will be understood that various modifications may be made without departing from the spirit and scope of this disclosure. For example, more than the three discussed methods may be employed with the untethered downhole tool. Additionally, another similar untethered downhole tool may choose to have more or less electromagnet groups. Accordingly, other embodiments are within the scope of the following claims.

What is claimed is:

1. A method for generating vertical seismic profile of a subsurface formation, the method comprising:
deploying an untethered downhole tool into a wellbore, the untethered tool comprising:
at least one seismic sensor; and
ballast such that, with the ballast, the untethered downhole tool has a higher density than fluid in the wellbore and, without the ballast, the untethered downhole tool has a lower density than fluid in the wellbore;
activating a first electromagnet in the untethered downhole tool to attach the untethered downhole tool to a casing of the wellbore at a predetermined depth;
transmitting a seismic signal into the subsurface formation from a source located above the subsurface formation;
receiving, with the at least one seismic sensor, the seismic signal;
deactivating the first electromagnet to release the untethered downhole tool from the casing of the wellbore;
releasing the ballast from the untethered downhole tool such that buoyancy effects move the tool uphole; and
retrieving the untethered downhole tool from the wellbore.

2. The method of claim 1, wherein the untethered tool comprises multiple seismic sensors.

3. The method of claim 1, wherein the first electromagnet deactivates and later reactivates to attach the untethered downhole tool to a different location in the wellbore.

4. The method of claim 1, further comprising determining depth of the untethered downhole tool in the wellbore from fall time.

5. The method of claim 1, further comprising loading multiple predetermined depths onto the untethered downhole tool corresponding to where data is to be measured onto an internal memory structure.

6. The method of claim 1, further comprising taking one or more measurements while descending to the predetermined depth.

7. The method of claim 1, further comprising taking one or more measurements while ascending for retrieval.

8. The method of claim 1, further comprising multiple untethered downhole tools deployed in the same wellbore.

9. The method of claim 8, wherein the first electromagnets deactivate and later reactivate to attach the untethered downhole tools to different locations in the wellbore.

10. The method of claim 8, wherein one untethered downhole tool is deployed for each predetermined depth.

11. The method of claim 9, wherein the deactivation and reactivation of the first electromagnets is synchronized for the multiple untethered downhole tools.

12. The method of claim 9, wherein the deactivation and reactivation of the first electromagnets is synchronized such that only one untethered downhole tool is retrieved at a time.

13. A buoyant deployable sensor apparatus comprising:
a microcontroller further comprising;
an internal memory structure,
wherein the memory structure contains data on predetermined times the deployable sensor is to measure data; and
contains predetermined times where the deployable sensor is to activate or deactivate one or more electromagnets;
a precision timer;
one or more electromagnets; and
a form of ballast that electromagnetically couples to the one or more electromagnets.

14. The apparatus of claim 13, wherein the deployable sensor is a seismic sensor.

15. The apparatus of claim 13, wherein the deployable sensor comprises a geophone, hydrophone, accelerometer, or fiber optic sensor.

16. The apparatus of claim 13, further comprising additional sensors for pressure, temperature, electromagnetism, acceleration, casing collar location and gamma rays.

17. The apparatus of claim 13, wherein the one or more electromagnets comprise multiple groups of electromagnets.

18. The apparatus of claim 17, wherein at least one of the multiple groups of electromagnets are positioned to electromagnetically couple the buoyant deployable sensor apparatus to a ferrous surface.

19. The apparatus of claim 18, wherein the ferrous surface is a wellbore.

20. The apparatus of claim 13, wherein the ballast is positioned such that gravity separates it from the buoyant deployable sensor apparatus upon deactivating the one or more electromagnets.
